(19) United States
(12) Patent Application Publication
(10) Pub. No.: US 2007/0196606 A1
(43) Pub. Date: Aug. 23, 2007

(54) Novel Method and Device for Securing Socks and Stockings

(76) Inventor: Christine Marie Cosme, Hobart, IN (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/677,273

(22) Filed: Feb. 21, 2007

Related U.S. Application Data
(60) Provisional application No. 60/775,314, filed on Feb. 21, 2006.

(51) Int. Cl. B60R 21/16; B32B 1/08

(52) U.S. Cl. 428/36.1

(57) ABSTRACT

A method and device for securing a pair of socks or stockings comprising an elastic type band which is affixed by its respective ends to the top inner portion of a sock or stocking, said band having a small open middle section permitting a second sock or stocking to be secured to the first sock or stocking when pulled through the middle section of the band to the mid-point of the sock.

### CROSS REFERENCE TO RELATED APPLICATION

This application claims benefit to provisional application 60/775,314 filed on Feb. 21, 2006, entitled Novel Method and Device for Securing Socks and Stockings, which is incorporated herein by reference in its entirety.

### FIELD OF THE INVENTION

The present invention is directed towards systems and implements for holding socks and stockings together when being laundered and stored.

### BACKGROUND OF THE INVENTION

One aspect of modern life which can quickly become a tedious and frustrating task is that of finding matching socks and stockings after they have been laundered. When socks and stockings go missing, which is a frequent occurrence, a major inconvenience is had, as this can quickly become time consuming and costly. Often the socks and stockings which become misplaced result in replacement expenses. From this, there is a long felt need in many households to easily secure paired socks in such a way that, after being laundered, every sock and stocking has its match.

There have been a number of U.S. patents directed to sorting and holding socks and stockings in an attempt to fill this need. U.S. Pat. No. 6,588,633 to Annam, for example, discloses a device for holding socks or stockings in pairs. The device consists of a holding body and a hook, which are joined by a predetermined breaking point. A slit is arranged in the holding body for receiving two socks or stockings. The slit is enclosed on all sides by the holding body. The device is produced easily and holding the socks or stockings securely and in a caring manner.

U.S. Pat. No. 6,279,169 to Reichle discloses a sock sorting and storage device comprising two clamping elements: the first having identifying indicia on its base and a plurality of solid posts extending therefrom, and the second having a corresponding plurality of internally hollow posts extending from a common base and each ending into sharp closed pointed ends. The interiors of the hollow posts comprise locking channels that are open at the base, extending through said base, and sealed at the closed pointed ends. In use, the solid posts are received and permanently and fixedly secured in their corresponding locking channels using fastening means provided on the lateral surfaces of the solid posts and the lateral interior surfaces of the internally hollow posts. The device is attached to the sock by piercing the sock with the pointed end of the internally hollow post and achieving intimate contact of its base with the sock, clipping the excess length extending beyond the penetrated sock to expose the locking channel at the pointed end, and penetrating the thusly exposed channel and receiving within it the solid post so that the sock is secured between the two fastened clamping elements. Sock pairs are sorted with the device provided in identical pairs, each pair comprising a first and a second clamping element. The sorted sock pairs are secured together for storage using attachment means provided on the two device second clamping elements.

U.S. Pat. No. 5,321,855 discloses an improved hook and loop reusable and reclosable fastening system for pairing socks, hosiery and gloves. The fastening system is permanently attached to the socks and hosiery. A preferred embodiment includes an elastic or other stretchable backing material attached to each hook and loop panel preferably made up of thin separable strips which can move with the expansion and contraction of the sock and attachment material. Another preferred embodiment includes several thin strips of the hook and loop panels attached directly to each sock, so that the sock itself can serve as a stretchable backing material. Another preferred embodiment is that each hook and loop panel, respectively, is attached to a logo or decorative pattern on the sock to camouflage the particular hook and loop panel. The products, such as socks, hosiery, gloves and the like can be attached by the hook and loop attachment means for washing, drying and storage. The VELCRO type fasteners are able to withstand the high temperature and forces encountered during the washing and drying process.

U.S. Design Pat. No. D363,579 to Scaglione et al. has an issue date of Oct. 24,1995. This invention is directed to the ornamental design of a clip to hold a pair of socks through wash and dry cycle and for storage.

U.S. Design Pat. No. D328,393 to Spavold has an issue date of Aug. 4, 1992. This invention is directed to the ornamental design for a holder for sorting socks or the like.

The various prior art referenced above are characterized by the inclusion of complex mechanical apparatuses, snaps or clamps. It would be desirable to provide a system in which socks and stockings could be attached together by a simple mechanism integral with the sock or stocking itself.

It is an object of the present invention to provide a simple system by which socks and stockings may be secured together when laundered and stored.

### SUMMARY OF THE INVENTION

In accordance, the invention is a method and device for securing a pair of socks or stockings comprising an elastic type band which is affixed by its respective ends to the top inner portion of a sock or stocking, said band having a small open middle section permitting a second sock or stocking to be secured to the first sock or stocking when pulled through the middle section of the band to the mid-point of the sock.

In a further embodiment, the invention is the method and device of the above described embodiment wherein the elastic band is located on the outside of the first sock to provide added security during heavier laundering.

In yet a further embodiment, the invention is method and device for securing a pair of socks or stockings comprising an elastic band which is affixed by its respective ends to the top inner portion of a sock or stocking by means of sewn thread, said band having a small open middle section permitting a second sock or stocking to be secured to the first sock or stocking when pulled through the middle section of the band to the mid-point of the sock.

In still yet a further embodiment, the invention is the method and device of the above described embodiment wherein the elastic band is located on the outside of the first sock to provide added security during heavier laundering.

### BRIEF DESCRIPTION OF THE FIGURES

FIG. 1 is a perspective view of the present invention in its preferred embodiment.

FIG. 2 is a side view of the present invention demonstrating its application.

### DETAILED DESCRIPTION OF THE PRESENT INVENTION

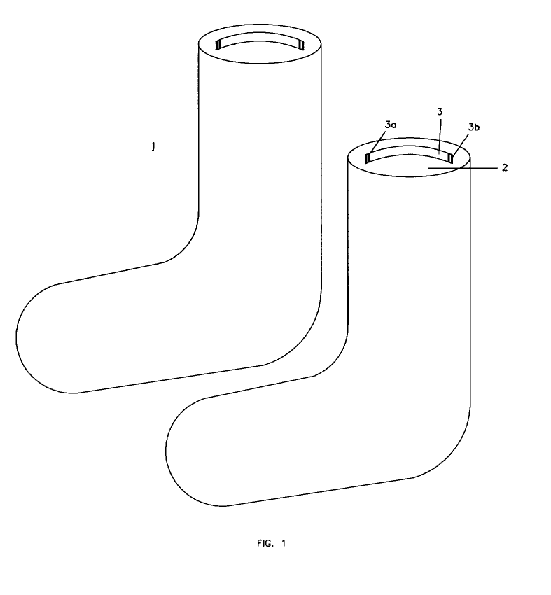

Overall, the present invention is an elastic type band existing on a sock or stocking to enable a pair of socks or stockings to be secured to one another. Referring to FIG. 1, socks or stockings 1 are shown paired in the manner which a consumer would typically find them sold in a retail store. One or both of the socks or stockings 1 from said pair will have an elastic type band 3 affixed crosswise to the top inner portion 2 of the sock or stocking, said band 3 being attached to the respective ends 3a, 3b of the top inner portion 2. In a preferred embodiment, the band 3 will measure approximately 1½ inches long by ½ inches wide but may be modified for size variation compatibility, i.e. a smaller band for a child's sock.

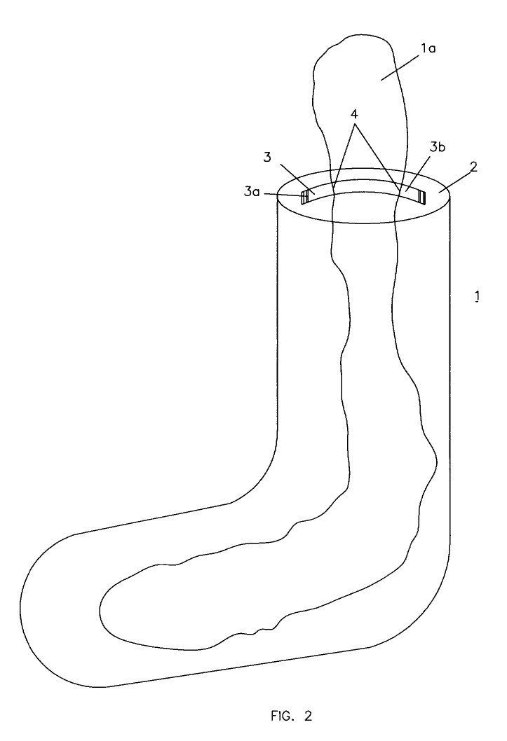

As shown in FIG. 2, the elastic type band 3 is to be tightly secured on both of its ends 3a, 3b by a means, i.e. sewn threading, so as to leave the middle section 4 of the band 3 with a small and tight opening. The elastic should provide enough stretch to let the second sock or stocking 1 a from the pair to be placed through said middle section 4 of the band 3 and pulled to its mid-point. The elastic type band 3 will then tightly hold the socks or stockings together, which results in their being securely locked for laundering and storing. The band 3 will not be visible unless the socks are removed and, due to its flat shape, the band cannot be seen or felt by the wearer.

In a further embodiment, the band 3 can be located on the outside of the sock or stocking. In such way, the band may still hold the pair of socks together tightly, even during heavy laundering. In each variation or embodiment, the invention prevents the socks or stockings which it secures from becoming misplaced or lost after being laundered in a simple, yet efficient way.

While the present invention has been described with reference to the above detailed description, it is to be appreciated that the true nature and scope of the invention will become apparent from the claims appended hereto.

I claim:

1. A method and device for securing a pair of socks or stockings comprising:
an elastic type band which is affixed by its respective ends to the top inner portion of a sock or stocking,
said band having a small open middle section permitting a second sock or stocking to be secured to the first sock or stocking when pulled through the middle section of the band to the mid-point of the sock.

2. The method and device of claim 1 wherein the elastic band is located on the outside of the first sock to provide added security during heavier laundering.

3. A method and device for securing a pair of socks or stockings comprising:
an elastic band which is affixed by its respective ends to the top inner portion of a sock or stocking by means of sewn thread,
said band having a small open middle section permitting a second sock or stocking to be secured to the first sock or stocking when pulled through the middle section of the band to the mid-point of the sock.

4. The method and device of claim 2 wherein the elastic band is located on the outside of the first sock to provide added security during heavier laundering.
